(19) United States
(12) Patent Application Publication
(10) Pub. No.: US 2022/0107180 A1
(43) Pub. Date: Apr. 7, 2022

(54) AN INERTIAL MEASUREMENT UNIT AND METHOD OF OPERATION

(71) Applicant: PRECISION MINING AND DRILLING HOLDINGS PTY LTD, Malaga (AU)

(72) Inventors: Hayden Scott Thomas WALKER, Bullsbrook (AU); Peter BULLOCK, Willeton (AU); David MIITEL, Forrestfield (AU)

(73) Assignee: PRECISION MINING AND DRILLING HOLDINGS PTY LTD, Malaga (AU)

(21) Appl. No.: 17/429,895

(22) PCT Filed: Feb. 11, 2020
(86) PCT No.: PCT/AU2020/050110

§ 371 Date: Aug. 10, 2021

(30) Foreign Application Priority Data
Feb. 11, 2019 (AU) 2019900432

(51) Int. Cl. G01C 19/06; G01C 19/42; G01P 15/14; E21B 47/024

(52) U.S. Cl. CPC G01C 19/065; E21B 47/024; G01P 15/14; G01C 19/42

(57) ABSTRACT

The present invention relates generally to the field of inertial measurement units (IMU's) and their use in downhole applications and particularly to an IMU configured to allow a calculation of bias or drift, an encoder steering assembly and a drilling target indicator to calculate position of a downhole implement relative to an intended path.

### TECHNICAL FIELD

The present invention relates generally to the field of inertial measurement units (IMU' s) and their use in downhole applications and particularly to an IMU configured to allow a calculation of bias or drift, an encoder steering assembly and a drilling target indicator to calculate position of a downhole implement relative to an intended path.

### BACKGROUND ART

An inertial measurement unit (IMU) is an electronic device that measures and reports a body's specific force, angular rate, and sometimes the magnetic field surroundings the body, using a combination of accelerometers and gyroscopes, sometimes also magnetometers. IMUs are typically used to manoeuvre aircraft, including unmanned aerial vehicles (UAVs), among many others, and spacecraft, including satellites and landers. Recent developments allow for the production of IMU-enabled GPS devices. An IMU allows a GPS receiver to work when GPS-signals are unavailable, such as in tunnels, inside buildings, or when electronic interference is present.

An inertial measurement unit works by detecting linear acceleration using one or more accelerometers and rotational rate using one or more gyroscopes. Some also include a magnetometer which is commonly used as a heading reference. Typical configurations contain one accelerometer, gyro, and magnetometer per axis for each of the three axes of direction, (X-axis, y-axis and z-axis, commonly referred to as pitch, roll and yaw for vehicles).

A major disadvantage of using IMUs for navigation is that they typically suffer from accumulated error. As the guidance system is continually integrating acceleration with respect to time to calculate velocity and position, any measurement errors or bias, however small, accumulate over time. This leads to ‘drift’: an ever-increasing difference between where the system thinks it is located and the actual location. Due to integration a constant error in acceleration results in a linear error in velocity and a quadratic error growth in position. A constant error in attitude rate (gyro) results in a quadratic error in velocity and a cubic error growth in position.

Positional tracking systems like GPS can be used to continually correct drift errors (an application of the Kalman filter). This correction mechanism requires access to a positional tracking system which discounts the use of positional tracking correction for underground mining applications for example.

Another correction mechanism is to rotate the IMU through 180° from a home orientation, gathering data and then comparing the data gathered in the rotated orientation with the data gathered in the home orientation.

This “drift” or “bias” and its correction is even more difficult in the context of an inertial measurement unit that is subject to dimensional constraints such as an IMU used in “down hole” situations in underground mining or blasting for example. Typically, the constraints in these situations are such that the gyroscopes of the IMU have a limited range of rotations, normally being able to rotate about one axis only.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an inertial measurement unit and method of operation, which may at least partially overcome at least one of the abovementioned disadvantages or provide the consumer with a useful or commercial choice.

With the foregoing in view, the present invention in one form, resides broadly in an inertial measurement unit including at least one sensor device mounted on an X-axis, Y-axis and Z-axis and at least one secondary sensor device mounted on the X-axis, Y-axis or Z-axis wherein the at least one secondary sensor device is mounted to be rotatably indexed relative to the X-axis, Y-axis or Z-axis independently relative to the at least one sensor device.

The inertial measurement unit of this form of the invention allows rotation of a secondary sensor device relative to the at least one sensor device which in turn provides the IMU with the ability to calculate a bias, preferably for each at least one sensor device in the IMU to allow correction, all while the IMU is in situ in “down hole” situations in underground mining or blasting for example.

In one form though not the only form, the invention relates to an inertial measurement unit configured for use with a downhole implement, comprising:
a primary casing removably and coaxially attached to a guide rod which is locatable within the hollow interior or bore of the downhole implement and can translate along the length of the implement;
a secondary casing enclosing the primary casing;
a primary sensor device mounted in the primary casing to measure acceleration and/or angular rate on at least one of an X-axis, Y-axis and Z-axis;
a secondary sensor device mounted in the secondary casing to measure acceleration and/or angular rate on at least one of an X-axis, Y-axis and Z-axis; and
wherein during an indexing process, the secondary sensor is adapted to be rotatably indexed relative to at least one of the X-axis, Y-axis and Z-axis independently of the primary sensor to thereby provide information regarding bias of the inertial measurement unit on at least one of the X-axis, Y-axis and Z-axis.

In another form though not the only form, the invention relates to a method of determining bias in an inertial measurement unit comprising a primary sensor device and a secondary sensor device comprising the steps of:
fixing the location and orientation of the primary sensor device;
indexing the secondary sensor device in a first axis through 90° of rotation relative to the primary sensor device;
indexing the primary sensor device and secondary sensor device in an axis perpendicular to the first axis through 180° of rotation;
indexing the secondary sensor device in the first axis though −90° of rotation;

indexing the primary sensor device and secondary sensor device in the axis perpendicular to the first axis through −180° of rotation; calculating the bias of the inertial measurement unit relative to the first axis using the data collected by the primary sensor device and secondary sensor device.

In another form though not the only form, the invention relates to an encoder steering assembly for steering an inertial measurement unit relative to a downhole implement comprising:
a housing insertable into the hollow bore of the downhole implement;
an encoder wheel configured to rotate about a first axis;
a mounting assembly configured to rotate about a second axis;
a drive to rotate the mounting assembly about the second axis;
wherein the encoder wheel is mounted in the mounting assembly such that the first axis and the second axis are perpendicular; and
wherein the inertial measurement unit and mounting assembly is mounted in the housing such that the encoder wheel can steer the housing relative to the downhole implement.

In another form though not the only form, the invention relates to a drilling target indicator including a display configured to display an indication of drill tip current position relative to drill tip target position and an angle of deflection required to arrive at the target position from the current position, wherein the angle of deflection determined according to the method including the steps of:
establishing a collar position of the drill rod associated with the drill tip;
calculating coordinates to establish the drill tip current position within a hole as drilling is underway; and
calculating an angle of deflection required to arrive at the target position from the current position.

In another form though not the only form, the invention relates to a method of increasing the effective rate of rotation at which an inertial measurement unit comprising a sensor and housing operates, comprising the step of: rotating the sensor in an opposite direction to a rotation of the housing such that the sensor remains within a functional limit to rate of rotation.

The present invention includes an inertial measurement unit. The inertial measurement unit will preferably have a primary casing and a secondary casing with the primary casing preferably including the at least one sensor device mounted on an X axis, y-axis and z-axis and the secondary casing enclosing the primary casing and the at least one secondary sensor device mounted on the x-axis, y-axis or z-axis.

Preferably, the primary casing will be rotatable relative to the secondary casing. This will preferably allow rotation of the at least one secondary sensor device relative to the primary casing as well as rotation of the primary casing relative to the secondary casing.

The inertial measurement unit of the present invention will preferably be used in a downhole situation. The inertial measurement unit will typically be mounted relative to an implement which is used in a downhole situation such as a drill rod, sucker rod, placement rod or like. Preferably, the inertial measurement unit of the present invention will be mounted on a placement or guide rod which is locatable within the hollow interior or bore of an elongate drill rod.

The inertial measurement unit may remain in the use location or may be inserted and removed from the downhole situation. Preferably, the inertial measurement unit will remain in situ and the indexing will preferably take place in situ and while the downhole implement, for example a drill rod is in use.

The present invention includes at least one sensor device mounted on an x-axis, y-axis and z-axis. In a particularly preferred embodiment, the at least one sensor device will be or include at least one primary sensor to measure acceleration and/or angular rate. Preferably, at least one, and typically more than one accelerometer is provided. Preferably, at least one, and typically more than one gyroscope or similar angular rate measurement sensor will be provided.

In a preferred embodiment of the present invention, the inertial measurement unit will be provided with three primary accelerometers and three primary gyroscopes, one accelerometer and one gyroscope provided for measurement of data including acceleration and angular rate in each of the x-axis, y-axis and z-axis. Preferably, the primary sensors will be provided within the primary casing. In a preferred embodiment, the primary sensors will be tasked with providing acceleration and angular rate data in relation to each of the x-axis, y-axis and z-axis.

Each of the primary sensors will preferably be fixed relative to the primary casing. In other words, rotation of the primary sensors will typically require rotation of the primary casing. The preferred configuration of three primary accelerometers and three primary gyroscopes will typically be provided as an inertial measurement unit to provide primary information.

Any type of primary sensors can be provided. Preferably, the sensors will be provided in the form of one or more MEMS sensors and/or one or more fibre-optic sensors.

Typically, the primary casing is attached removably relative to a downhole implement. Preferably, the primary casing is provided coaxially with the downhole implement and the primary casing may move along the implement, that is it may translate along the length of the implement and/or the primary casing may move radially relative to the implement, that is toward and away from the central axis of what will normally be a substantially cylindrical downhole implement.

The location and orientation of the primary casing in particular will preferably be fixed during at least a portion of the indexing process. As mentioned above, the primary sensor devices will preferably be fixed relative to the primary casing, but the entirety of the primary casing will preferably be movable relative to the secondary casing and the downhole implement. Preferably, the primary casing will be rotatably indexable. Preferably, the primary casing will be indexed through 180° increments.

The present invention also includes at least one secondary sensor device mounted on the x-axis, y-axis or z-axis wherein the at least one secondary sensor device is mounted to be rotatably indexed relative to the x-axis, y-axis or z-axis independently relative to the at least one sensor device.

The at least one secondary sensor device will typically be mounted within the secondary casing. Any type of secondary sensor device may be provided. The at least one secondary sensor device may be or include a sensor device to provide information on acceleration and/or angular rate.

Preferably, the at least one secondary sensor device will be or include a gyroscope. Whilst only one secondary sensor device may be required in order to calculate a bias, the present invention may provide increased accuracy if more than one secondary sensor device is provided. More than one secondary sensor device may be provided and, for example, a secondary sensor device may be provided for each of the x-axis, y-axis and/or z-axis. Typically, each of the secondary sensor device is rotatably indexable relative to the at least one sensor device and/or each other secondary sensor device.

Therefore, in a particularly preferred embodiment of the present invention, the invention will include three primary accelerometers, one primary accelerometer mounted relative to each of the x-axis, y-axis and z-axis within the primary casing, three primary gyroscopes, one primary gyroscope mounted relative to each of the x-axis, y-axis and z-axis within the primary casing and least one and typically three secondary gyroscopes, one secondary gyroscope mounted relative to each of the x-axis, y-axis and z-axis within the secondary housing. This configuration will allow use of one of the secondary gyroscopes to determine bias in each of the three axes.

Typically, the secondary sensor device will be rotatably indexed relative to the axis relative to which the at least one secondary sensor device is mounted.

In use, one of the secondary sensor devices will preferably be indexed relative to the at least one sensor device at a time. For example, if the bias in the z-axis is required, then the secondary gyroscope mounted relative to the z-axis will preferably be indexed in order to record/calculate the bias. The secondary gyroscope mounted relative to the z-axis may be used to compare the bias with the fixed z-axis primary sensor and then will typically remain in an indexed position whilst utilising the movement of the primary casing through 180° and then return to its original position thus completing the bias calculation. This will also allow comparison of the secondary z-axis gyroscope data with the primary fixed axis gyroscope data enabling calculation of the total bias associated with the inertial measurement unit. A similar process may be used to calculate bias in the x-axis and/or in the y-axis.

Preferably, if the bias in the z-axis is being calculated, then the secondary sensor in the z-axis will be indexed and the primary casing will typically be indexed relative to the same axis.

The drive mechanism for indexing in the present invention will preferably include one or more drive portions. Preferably, an external secondary housing will be provided with a drive portion in order to drive the indexing of the preferably internally mounted primary casing containing the at least one primary sensor. The drive portion will preferably drive the primary housing through indexed rotation.

Preferably, the primary casing will also be provided with a drive portion in order to drive the at least one secondary device rotatably and through one or more index positions.

As mentioned above, the primary casing will normally be indexed through two positions which are substantially 180° of rotation apart, preferably in each of the three axes. Preferably, each of the secondary sensor devices will preferably be indexed through at least two positions which are substantially 90° of rotation apart.

In a preferred configuration, the primary casing will preferably act as a drive base for the at least one secondary sensor device and rotation of the at least one secondary sensor device will typically occur relative to the primary casing.

This preferred mechanism of indexing calibration preferably requires multiple indexing operations to be carried out for each of the x-axis y-axis and z-axis. This method will preferably provide for rotation of the at least one secondary sensor device in one axis through 90° and rotation of the primary casing including the primary sensor devices through 180° of rotation using the relative flotation to calculate the bias error of each primary sensor device.

Further this preferred configuration provides a dynamic IMU rotation compensation method, that off sets any outside rotational force that may rotate the IMU housing. The IMU may be dynamically rotated in the opposite direction of the outside rotational forces enabling the IMU to be rotated into a vertical position and allowing the IMU to provide Z-axis angular rate calculations at higher rotations. A dynamic roll compensation method can calculate the dynamic position of the IMU being mounted on the Z-axis of the IMU housing into the upright home position (gravity vector or any designated vector).

This method allows a measurable, stable position for improved bias measurements that can be used for each “MEMS Sensor” or “Fibre Optic Sensor” during IMU or gyroscope indexing and or any movement of the IMU associated with the IMU rotation operation.

In another form, the present invention resides in an encoder steering assembly to steer an inertial measurement unit provided relative to a downhole implement, the encoder steering assembly including at least one encoder wheel mounted for rotation about a first axis, an encoder wheel mounting assembly mounting the at least one encoder wheel, the encoder wheel mounting assembly mounted for rotation relative to a second axis angled relative to the first axis and a drive to drive rotation of the encoder wheel mounting assembly to steer the at least one encoder wheel.

The encoder steering assembly of the present invention allows the mounting of an inertial measurement unit (IMU) relative to a downhole implement such as the drill rod. Typically, the insertion of an inertial measurement unit (or changing the depth of an inertial measurement unit) in a hollow bore of the drill rod causes the inertial measurement unit to rotate relative to the drill rod during the movement. The encoder steering assembly of the present invention will preferably allow “steering” of the inertial measurement unit and/or or a housing containing an inertial measurement unit relative to the drill rod as the inertial measurement unit is moving relative to the drill rod.

In a preferred configuration, the housing relative to which the inertial measurement unit is mounted is typically mounted in line on a placement rod or similar. The placement rod can typically rotate relative to the drill rod in the hollow bore of the drill rod. Typically, the housing relative to which the inertial measurement unit is mounted may rotate relative to the placement rod and/or the drill rod.

Typically, the at least one encoder wheel will extend outside the housing relative to which the inertial measurement unit is mounted. Typically, the at least one encoder wheel will abut an inner surface of the drill rod. In this configuration, adjusting the angle of the at least one encoder wheel will typically steer the IMU as the IMU moves relative to the hollow drill rod. This may cause rotation of the housing relative to which the IMU is mounted.

As mentioned above, the downhole implement relative to which the encoder steering assembly will typically be used will normally be an elongate drill rod or similar. Preferably, the elongate drill rod or similar downhole implement will have an elongate hollow bore extending through the centre of the implement.

The encoder steering assembly of the present invention also includes at least one encoder wheel mounted for rotation about a first axis. Normally a single steerable encoder wheel will be provided on any assembly. Typically, the first axis is substantially perpendicular to the at least one encoder wheel. The at least one encoder wheel will typically be mounted relative to an axle or similar. The at least one encoder wheel will typically rotate with the axle. In some forms, the encoder wheel may be a driven wheel.

The encoder wheel may be provided with a high friction periphery to allow attraction to be created between the encoder wheel and the internal surface of the downhole implement. As mentioned above, it is preferred that the encoder wheel is mounted relative to the housing such that at least a portion of the encoder wheel extends outside the housing to abut an internal surface of the downhole implement.

The encoder wheel may be biased outwardly preferably into abutment with an interior surface of a hollow downhole implement.

A drive may be provided in order to adjust the extent to which the encoder wheel extends outside the housing. This drive may be remotely operable so that the operator can adjust the extent to which the encoder wheel extends outside the housing.

In a preferred form, the encoder wheel typically be solid. The encoder wheel may be formed of any material which is appropriate to the purpose and the conditions.

The present invention includes an encoder wheel mounting assembly mounting the at least one encoder wheel and the encoder wheel mounting assembly itself mounted for rotation relative to a second axis angled relative to the first axis. Any type of mounting assembly may be used. In a preferred embodiment, the encoder wheel mounting assembly includes a ring or part ring which mounts to the preferred axle of the at least one encoder wheel. Rotation of the ring will typically change the angle of the axle thereby steering the at least one encoder wheel.

Preferably, the mounting ring is mounted relative to a drive to drive rotation of the ring as required. Typically, the drive is a powered drive which is remotely operated by an operator.

An engagement assembly is preferably provided in association with the ring in order to engage the drive. Preferably, the engagement assembly is or includes a number of teeth and the drive will preferably include a corresponding mechanism.

The drive is preferably controlled by a microprocessor in order to rotate the drive to rotate to the ring as required to change the angle of the axle. Through contact of the encoder wheel with the inside of the downhole implement, changing the angle of the axle will act to steer the inertial measurement unit relative to the downhole device.

As mentioned above, the encoder steering assembly is typically provided relative to a housing and housing is preferably provided relative to a placement rod or similar. Preferably, the housing will be elongate. The housing is preferably provided with at least one, and preferably more than one stabiliser wheels or structures on an exterior portion and the stabiliser wheels or structures will typically also abut an internal surface of the downhole implement. The at least one stabiliser wheels or structures will preferably be provided on the opposite side of the housing to the steerable encoder wheel. Typically, the stabiliser wheels or structures will be able to freely rotate. Any material which is suitable to the purpose and/or environment may be used for the stabiliser wheels or structures.

In another form, the present invention resides in a drilling target indicator including a display configured to display an indication of drill tip current position relative to drill tip target end position and at least one calculated angle of deflection required to arrive at the target end position from the current position, the at least one calculated angle of deflection calculated according to the method including the steps of:
a) establish a collar position of the drill rod;
b) Calculate coordinates to establish the drill tip current position within a drill hole as drilling is underway, at a time of survey, tsmvey; and
c) Calculate at least one calculated angle of deflection required to arrive at the target end position from the current position.

The drilling target indicator of a preferred embodiment will preferably provide an indication to an operator of any deviation of a drill rod or similar downhole implement from an intended path given a fixed position (opposition) at or adjacent to the ground surface and an intended target end position. The drilling target indicator may provide an indication of the deviation from an intended path and/or provide an indication of any correction required in order for an off target implement to achieve the intended target in position.

Typically, the drilling target indicator will ascertain the current position at a time of survey of the drill tip or downhole implement tip according to two parameters, namely dip and azimuth. Preferably, the drilling target indicator will ascertain any deviation (and/or correction) relative to one or both of these parameters.

Establishing the collar position may be achieved by defining a position as the collar position and/or by calculation, for example at Time, t=0 or at Depth=0.

Any method may be used to calculate the current position of the tip of the downhole implement. Preferably the current position of the tip of the downhole implement will be established in real time in order to provide appropriate feedback in a timely manner to an operator to allow them to take corrective action if necessary. Preferably, the method of the present invention will be implemented while drilling.

Once the current position of the tip of the downhole implement has been established, the correction angle can be calculated in one or both of the parameters, dip and azimuth.

Preferably, once calculated, the current position of the tip of the downhole implement relative to the intended path and/or correction angle will typically be displayed on a display for an operator controlling the operation so that the operator can take appropriate steps to correct, any deviation.

The method can be implemented at any time during a drilling operation or at preset times in order to provide the displayed indication.

Preferably, the calculations undertaken to establish the important parameters include one or more of the following equations:

$$\begin{matrix}{Depth}_{n} = \sqrt{( {( {Y}_{LINE , n} - {Y}_{LNE , n - 1} )}^{2} - {{ɛ}_{ψ , n}}^{2} - {{ɛ}_{ϕ , n}}^{2} )} in meters & I \\ {ɛ}_{ψ , n} = ( {Depth}_{n} - {Depth}_{n - 1} ) \times tan ( {ψ}_{n - 1} - {ψ}_{collar} ) in meters & II \\ {ɛ}_{ϕ , n} = ( {Depth}_{n} - {Depth}_{n - 1} ) \times tan ( {ϕ}_{n - 1} - {ϕ}_{collar} ) in meters & III \\ {ψ}_{correction , n} = {ψ}_{collar} - {tan}^{- 1} ( {\sum }_{n = i , i = 0} ( {ɛ}_{ψ , i} ) / ( {Depth}_{final} - {\sum }_{n - 1 , i = 0} ( {Depth}_{n} ) ) ) & IV \\ {ϕ}_{correction , n} = {ϕ}_{collar} - {tan}^{- 1} ( {\sum }_{n = i , i = 0} ( {ɛ}_{ϕ , i} ) / ( {Depth}_{final} - {\sum }_{n - 1 , i = 0} ( {Depth}_{n} ) ) ) & V \\ {Y}_{LINE , 0} = {Depth}_{0} = {ɛ}_{ψ , 0} = {ɛ}_{ϕ , 0} = {ψ}_{0} = {ϕ}_{0} = {ψ}_{correction , 0} = {ϕ}_{correction , 0} = 0 & VI\end{matrix}$$

### Wherein:

Depth is distance aligned down collar—“direct distance”
Y_{LINE} is measured distance of location via Wire-line counter
ε is an error value in meters
Correction is final heading recommended to return to ideal hole end point
ψₙ is the azimuth reading of the nth slot; and
ϕₙ is the dip reading of the nth slot

The method of calculating and rotating IMU into the upright home position, or gravity vector, or any designated vector, can be used to provide data to a microprocessor to enable the calculation, to drive the drive mechanism that is used to steer the IMU housing.

If needed, a laser and PSD (Position Sensing Device) can be fitted onto the individual Gyro/IMU that will locate the rotating gyro into the correct aligned position within the Gyro/IMU.

As an example, the fitment of at least one laser or LED device that can be fitted to at least one “MEMS Sensor” or “Fibre Optic Sensor” and at least one Position Sensitive Device (PSD) and or at least one mirror and or an inclinometer to measure the alignment of the at least one gyroscope within the IMU, to calculate the alignment of each gyro during the indexing process.

The present invention also provides the ability to use the dynamic rotation mechanism described above to establishes the vertical positioning of the device and to then calculate from that position and based upon the drill hole coordinates and the targeting calculation to direct the rotation of the one or more gyroscopes, or the IMU as a unit, to the best possible calibration (accounting for the earth's rotation) position for indexing and calibration.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic isometric view of a prior art inertial measurement device showing the conventional internal components.

FIG. 2 is a schematic illustration of a home position of an IMU including a secondary gyroscope according to a preferred embodiment of the present invention.

FIG. 3 is a schematic illustration of a first partly rotated position of secondary gyroscope in the IMU illustrated in FIG. 2.

FIG. 4 is a schematic illustration of a 90° rotated position of the secondary gyroscope in the IMU illustrated in FIG. 2.

FIG. 5 is a schematic illustration of a first partly rotated position of the IMU as illustrated in FIG. 4.

FIG. 6 is a schematic illustration of a 180° rotated position the IMU illustrated in FIG. 4.

FIG. 7 is a schematic illustration of a first partly rotated position of secondary gyroscope in the IMU illustrated in FIG. 6.

FIG. 8 is a schematic illustration of a 90° rotated position of secondary gyroscope in the IMU illustrated in FIG. 6.

FIG. 9 is a schematic illustration of a first partly rotated position of the IMU as illustrated in FIG. 8.

FIG. 10 is a schematic illustration of a 180° rotated position the IMU illustrated in FIG. 8 back to the home position.

FIG. 11 is a schematic representation of the structure of the IMU casings

FIG. 12 is a cutaway schematic view of the structure of the IMU casings

FIG. 13 is a schematic top view of a drilling target indication calculation according to a preferred embodiment of the present invention showing an azimuth calculation.

FIG. 14 is a schematic side view of a drilling target indication calculation according to a preferred embodiment of the present invention showing a dip calculation.

FIG. 15 is a schematic view of a further drilling target calculation method according to an embodiment of the invention

FIG. 16 is a schematic view of a drilling target indication display incorporating the calculations from FIGS. 13, 14 and 15.

FIG. 17 is a schematic view of an IMU with dynamic roll compensation.

FIG. 18 is a schematic end view of an IMU illustrating dynamic roll compensation.

FIG. 19 is an isometric view of a drill rod with an encoder wheel assembly of a preferred embodiment of the present invention provided thereon to steer an IMU.

FIG. 20 is a sectional end view of the configuration illustrated in FIG. 19.

FIG. 21 is an end view of the encoder wheel assembly illustrated in FIG. 19.

FIG. 22 is an isometric view of an encoder steering wheel assembly removed from the assembly and according to a preferred embodiment.

### DESCRIPTION OF EMBODIMENTS

According to a particularly preferred embodiment of the present invention, an inertial measurement unit and method of operation is provided.

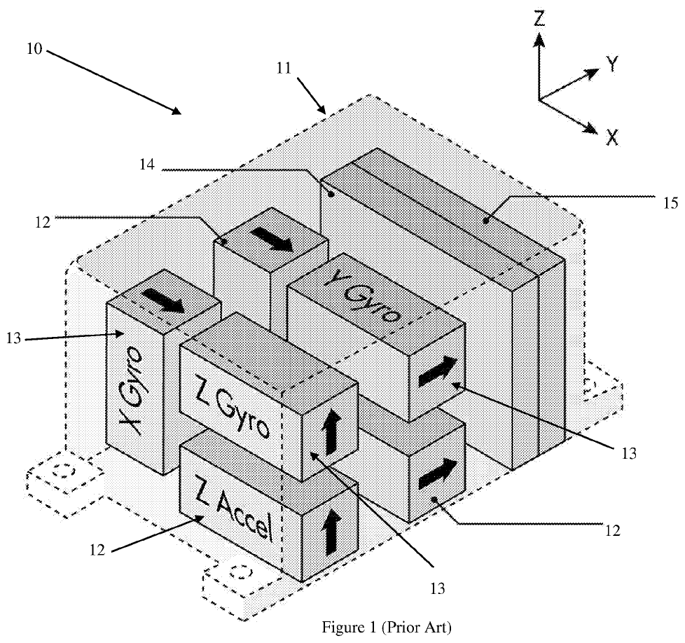

FIG. 1 shows a schematic illustration of a conventional inertial measurement unit 10 (IMU) with internal components. As illustrated, an IMU is typically composed of an outer enclosure 11 housing the follow components:
Three accelerometers 12, one for each of the X-axis, Y-axis and Z-axis;
Three gyroscopes 13, one for each of the X-axis, Y-axis and Z-axis;
Sensor electronics 14 to receive the signals from the accelerometers and the gyroscopes and convert to data; and
A computer 15 or similar operating signal processing software and/or communication software.

The three accelerometers 12 are mounted at right angles relative to each other so that acceleration can be measured independently in three axes: X, Y and Z. Three gyroscoped 13 are provided also at right angles to each other so that the angular rate can be measured around each of the acceleration axes.

The inertial measurement unit of the preferred embodiment includes a primary housing or casing with three primary accelerometers and three primary gyroscopes, one accelerometer and one gyroscope provided for measurement of data including acceleration and angular rate in each of the x-axis, y-axis and z-axis in a similar configuration to that illustrated in FIG. 1. Preferably the primary sensors will be provided within the primary casing. In a preferred embodiment, the primary sensors will be tasked with providing acceleration and angular rate data in relation to each of the x-axis, y-axis and z-axis. The preferred embodiment also includes three secondary gyroscopes 16, one secondary gyroscope mounted relative to each of the x-axis, y-axis and z-axis (and relative to the accelerometer and gyroscope in each of the x-axis, y-axis and z-axis) within a secondary housing. This configuration will allow use of one of the secondary gyroscopes to determine bias in each of the three axes.

The inertial measurement unit of this form of the invention allows rotation of each of the three secondary gyroscopes 16 relative to the primary housing (and the accelerometer and gyroscope in each of the x-axis, y-axis and z-axis within the IMU primary housing) which in turn provides the overall IMU with the ability to calculate a bias, preferably for each of the primary accelerometers and gyroscopes in each of the x-axis, y-axis and z-axis within the IMU primary housing in the IMU to allow correction, all while the IMU is in situ in “down hole” situations in underground mining or blasting for example.

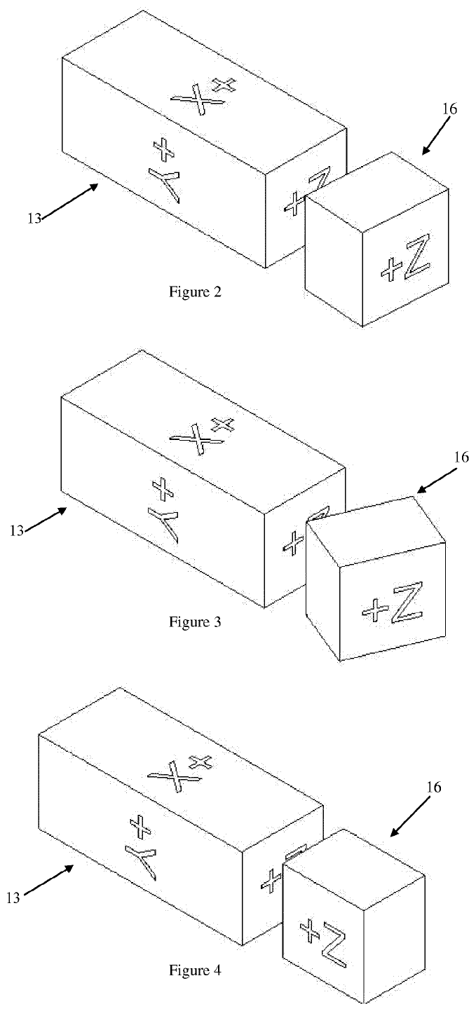

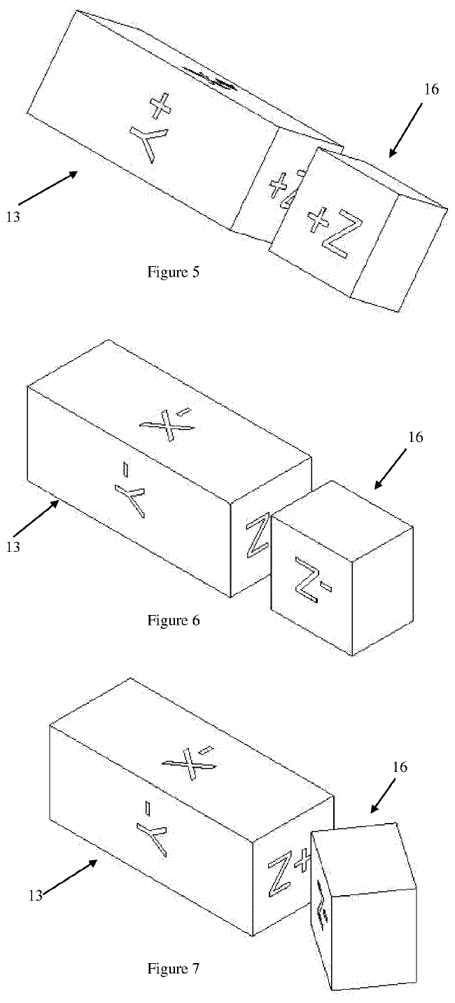

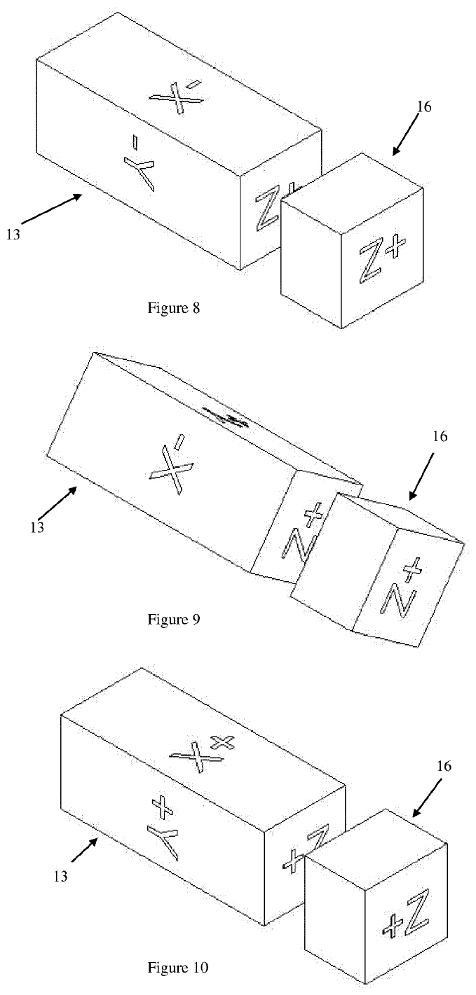

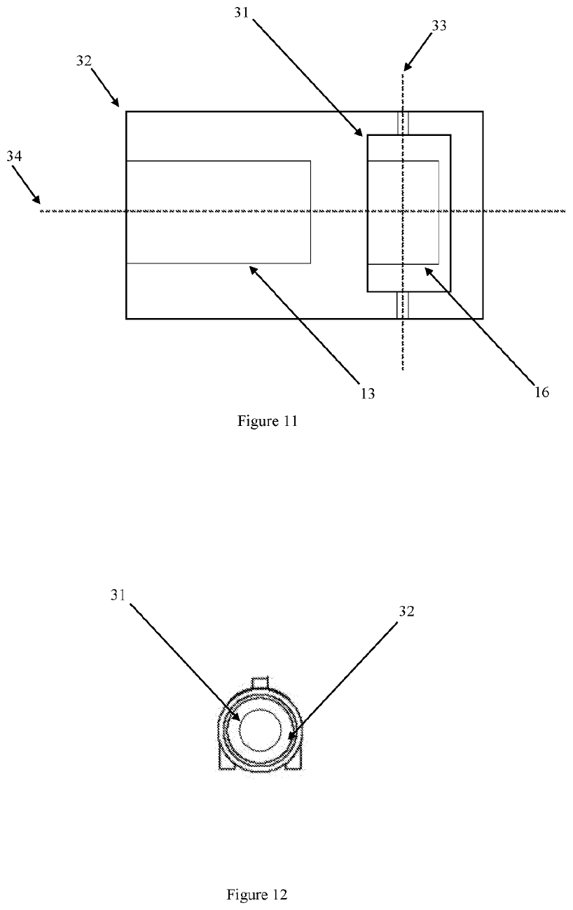

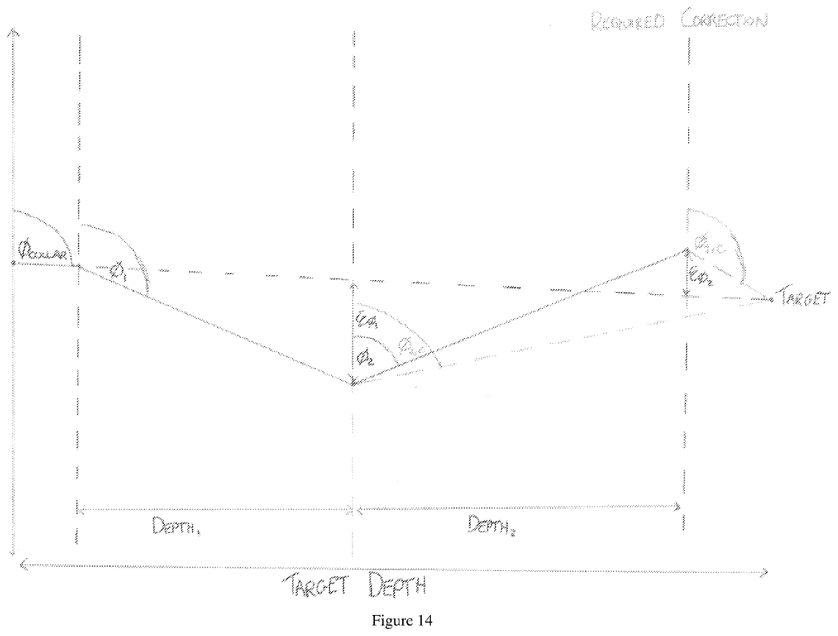

To simplify the illustration of the configuration and operation of the device, only the Z-axis primary gyroscope 13 and the Z-axis secondary gyroscope 16 of the IMU device of the preferred embodiment are illustrated in FIGS. 2 to 14.

As mentioned, the inertial measurement unit will preferably have a primary casing 31 and a secondary casing 32 with the primary casing including the primary devices mounted on an X axis, y-axis and z-axis and the secondary casing enclosing both the primary casing and the secondary devices mounted on the x-axis, y-axis and z-axis.

In the preferred embodiment, the primary casing is rotatable relative to the secondary casing. This configuration allows indexable rotation of the each of the secondary devices relative to the primary casing (and its components) as well as rotation of the primary casing (as a unit) relative to the secondary casing.

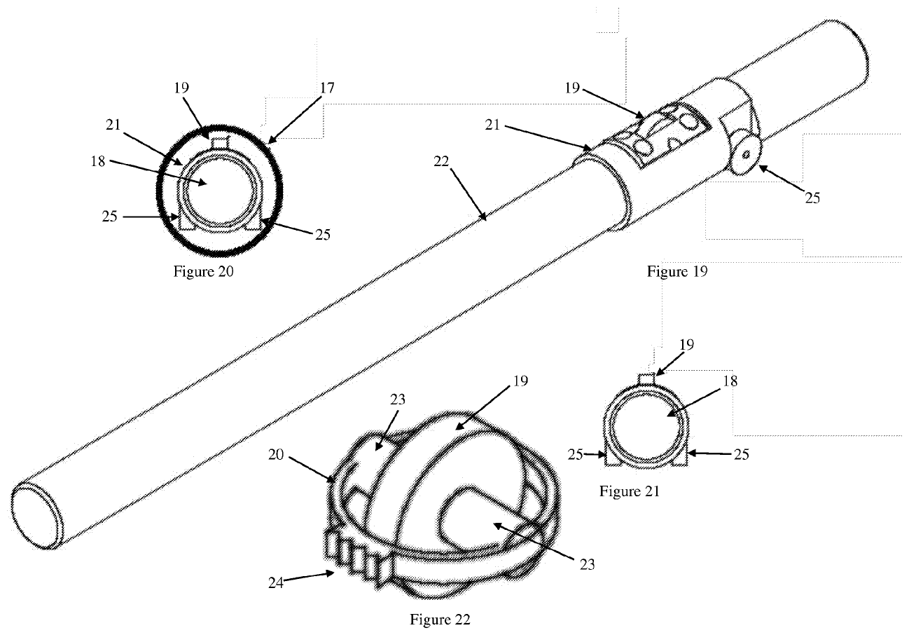

The inertial measurement unit will typically be mounted relative to an implement which is used in a downhole situation such as a drill rod, sucker rod, placement rod or like. The inertial measurement unit of the present invention will be mounted on a placement or guide rod which is locatable within the hollow interior or bore of an elongate drill rod similar to that illustrated in FIGS. 19 to 21.

The inertial measurement unit will typically remain in situ and the indexing and bias calculation (and correction) will take place in situ and while the downhole implement, for example a drill rod is in use without requiring that the IMU be removed from the drill rod.

As shown in FIG. 1, each of the primary sensor devices will normally be fixed relative to the primary casing. In other words, rotation of the primary sensors will typically require rotation of the whole primary casing. The preferred configuration of three primary accelerometers 12 and three primary gyroscoped 13 will typically be provided as an inertial measurement unit to provide primary information, within the secondary casing including the secondary devices for bias or drift calculation.

Any type of primary sensors can be provided. Preferably, the sensors will be provided in the form of one or more MEMS sensors and/or one or more fibre-optic sensors.

Typically, the primary casing is attached removably relative to a downhole implement. Preferably, the primary casing is provided coaxially with the downhole implement and the primary casing may move along the implement, that is it may translate along the length of the implement and/or the primary casing may move radially relative to the implement, that is toward and away from the central axis of what will normally be a substantially cylindrical downhole implement.

The location and orientation of the primary casing in particular will preferably be fixed during at least a portion of the indexing process. As mentioned above, the primary sensor devices are fixed relative to the primary casing, but the entirety of the primary casing is rotatably indexable relative to the secondary casing and the downhole implement. In a preferred form, the primary casing will be indexed through 180° increments.

The secondary sensor devices are mounted within the secondary casing. In the preferred configuration, the secondary sensor devices will each be or include a gyroscope. Whilst only one secondary sensor device may be required in order to calculate a bias, the present invention may provide increased accuracy if more than one secondary sensor device is provided. More than one secondary sensor device may be provided and, for example, a secondary sensor device may be provided for each of the x-axis, y-axis and/or z-axis. Typically, each of the secondary sensor device is rotatably indexable relative to each of the primary sensor devices and/or each other secondary sensor device.

Therefore, in a particularly preferred embodiment of the present invention, the invention will include three primary accelerometers, one primary accelerometer mounted relative to each of the x-axis, y-axis and z-axis within the primary casing, three primary gyroscopes, one primary gyroscope mounted relative to each of the x-axis, y-axis and z-axis within the primary casing and least one and typically three secondary gyroscopes, one secondary gyroscope mounted relative to each of the x-axis, y-axis and z-axis within the secondary housing. This configuration will allow use of one of the secondary gyroscopes to determine bias in each of the three axes.

Typically, the secondary sensor device will be rotatably indexed relative to the axis relative to which the at least one secondary sensor device is mounted.

In use, at least one of the secondary sensor devices is indexed relative to the respective primary sensor device at a time. For example, and according to the preferred configuration shown in FIGS. 2 to 10, if the bias in the z-axis is required, then the secondary gyroscope 16 mounted relative to the z-axis is indexed about an axis 33 in order to record/calculate the bias. The secondary gyroscope mounted relative to the z-axis is indexed through 90° and then remains in an indexed position whilst utilising the movement of the primary casing about a perpendicular axis 34 including the primary z-axis gyroscope 12 through 180° and then the secondary Z-axis gyroscope 16 returns to its original position thus completing the indexing and allowing the collection of data in each of the positions to enable bias calculation. This will also allow comparison of the secondary z-axis gyroscope 16 data with the primary fixed axis gyroscope 13 data enabling calculation of the total bias associated with the inertial measurement unit. A similar process may be used to calculate bias in the x-axis and/or in the y-axis.

Preferably, if the bias in the z-axis is being calculated, then the secondary sensor in the z-axis will be indexed and the primary casing will typically be indexed relative to the same axis.

A drive mechanism for indexing in the present invention will preferably include one or more drive portions. Preferably, an external secondary housing will be provided with a drive portion in order to drive the indexing of the preferably internally mounted primary casing containing the at least one primary sensor. The drive portion will preferably drive the primary housing through indexed rotation.

Preferably, the primary casing will also be provided with a drive portion in order to drive the at least one secondary device rotatably and through one or more index positions.

As mentioned above, the primary casing will normally be indexed through two positions which are substantially 180° of rotation apart, preferably in each of the three axes. Preferably, each of the secondary sensor devices will preferably be indexed through at least two positions which are substantially 90° of rotation apart.

In a preferred configuration, the primary casing will preferably act as a drive base for the at least one secondary sensor device and rotation of the at least one secondary sensor device will typically occur relative to the primary casing.

This preferred mechanism of indexing calibration preferably requires multiple indexing operations to be carried out for each of the x-axis y-axis and z-axis. This method will preferably provide for rotation of the at least one secondary sensor device in one axis through 90° and rotation of the primary casing including the primary sensor devices through 180° of rotation using the relative flotation is to calculate the bias error of each primary sensor device.

Further this preferred configuration provides a dynamic IMU rotation compensation method, that off sets any outside rotational force 37 that may rotate the IMU housing. The IMU may be dynamically rotated in the opposite direction 38 of the outside rotational forces enabling the IMU to be rotated into a vertical position and allowing the IMU to provide Z-axis angular rate calculations at higher rotations. A dynamic roll compensation method can calculate the dynamic position of the IMU being mounted on the Z-axis of the IMU housing into the upright home position (gravity vector or any designated vector).

Due to the shape of a traditional down-hole instrument, there is generally a low moment of inertia about the roll-axis. This leads to the instrument being rotated quickly about this axis during handling and normal operation, often beyond the rate measurable by a high-performance gyroscope.

To increase the rate at which the roll axis may be rotated before the gyroscope limits are surpassed, it is advantageous that the IMU be driven equally and oppositely to the outer housing 36 by a drive 35, thereby reducing the rate measured about the roll axis. With an encoder used to record the position relative to the outer housing 36 the IMU roll may still be accurately known.

The IMU is mounted such that it is rotatable about the roll axis. The IMU is also connected to a motor and an encoder.

This method allows a measurable, stable position for improved bias measurements that can be used for each “MEMS Sensor” or “Fibre Optic Sensor” during IMU or gyroscope indexing and or any movement of the IMU associated with the IMU rotation operation.

Illustrated in a preferred form in FIGS. 19 to 22 is an encoder steering assembly to steer an inertial measurement unit (IMU) 18 provided relative to a hollow downhole drill rod 17. The encoder steering assembly illustrated includes an encoder wheel 19 mounted for rotation about a first axis, and an encoder wheel mounting ring 20 mounting the encoder wheel 19. The encoder wheel mounting ring is mounted for rotation relative to a second axis angled relative to the first axis and a drive structure is provided on the ring to drive rotation of the encoder wheel mounting ring to steer the encoder wheel 19.

The encoder steering assembly of the present invention allows the mounting of an inertial measurement unit (IMU) relative to a downhole implement such as a drill rod 17. The insertion of an IMU (or changing the depth of an IMU) in a hollow bore of the drill rod 17 causes the IMU to rotate relative to the drill rod 17 during the movement. The encoder steering assembly allows “steering” of the IMU and/or or a housing containing an IMU relative to the drill rod 17 as the IMU is moved relative to the drill rod 17.

In a preferred configuration, a housing 21 relative to which the IMU is mounted is typically mounted in line on a placement rod 22 or similar. The placement rod 22 can rotate relative to the drill rod 17 in the hollow bore of the drill rod 17. Typically, the housing 21 relative to which the IMU is mounted can rotate relative to the placement rod 22 and/or the drill rod 17.

The encoder wheel 19 extends outside the housing 21 relative to which the IMU is mounted to abut an inner surface of the drill rod 17 (the configuration illustrated in FIG. 20 is spaced for clarity). In this configuration, adjusting the angle of the encoder wheel 19 steers the IMU as the IMU moves relative to the hollow drill rod 17. This may cause rotation of the housing 21 relative to which the IMU is mounted.

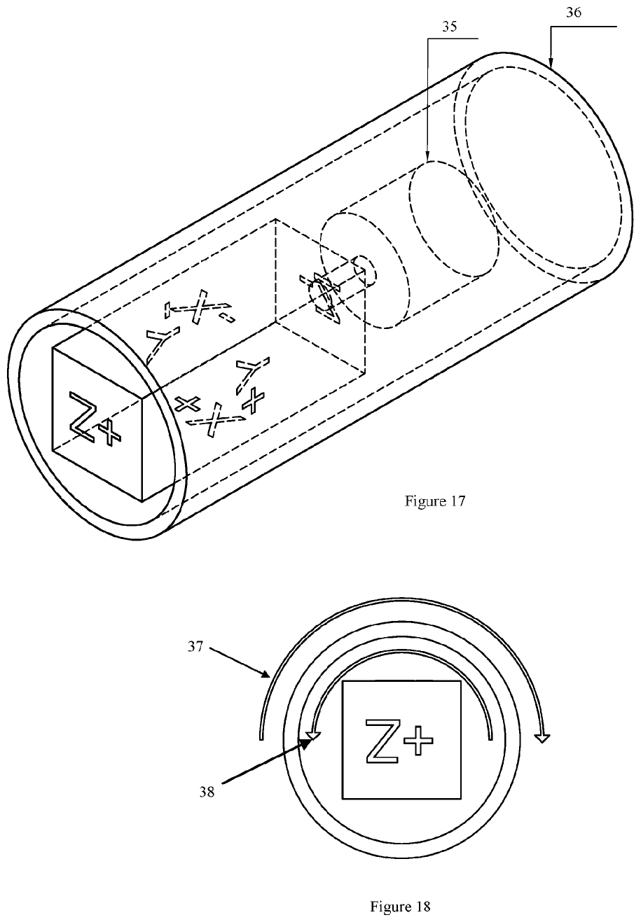

Normally a single steerable encoder wheel 19 is provided on any assembly. Typically, the first axis is substantially perpendicular to the encoder wheel 19 with the encoder wheel 19 typically mounted relative to an axle 23 as shown in FIG. 17. The encoder wheel 117 typically rotates with the axle 23.

The encoder wheel may be biased outwardly from the housing 23 to abut an internal surface of the drill rod 17.

As shown in FIG. 22, the encoder wheel mounting ring mounts the axle 23 of the encoder wheel 19. Rotation of the ring will change the angle of the axle 23 thereby steering the encoder wheel 19 and the associated IMU.

Preferably, the mounting ring is mounted relative to a drive to drive rotation of the ring as required. Typically, the drive is a powered drive which is remotely operated by an operator.

An engagement assembly 24 including a number of teeth is provided in association with the ring in order to engage the drive and the drive will preferably include a corresponding mechanism.

The drive is preferably controlled by a microprocessor in order to rotate the drive to rotate to the ring as required to change the angle of the axle 23. Through contact of the encoder wheel 19 with the inside of the drill rod 17, changing the angle of the axle 23 will act to steer the IMU relative to the drill rod 17.

As mentioned above, the encoder steering assembly is typically provided relative to a housing 21 and housing 21 of the illustrated embodiment is provided relative to a placement rod 22 or similar. The illustrated housing 21 is provided with a pair of stabiliser wheels 25 on an exterior portion and the stabiliser wheels 25 also abut an internal surface of the drill rod 17. The stabiliser wheels 25 are provided on the opposite side of the housing 21 to the steerable encoder wheel 19. Typically, the stabiliser wheels 25 are able to freely rotate.

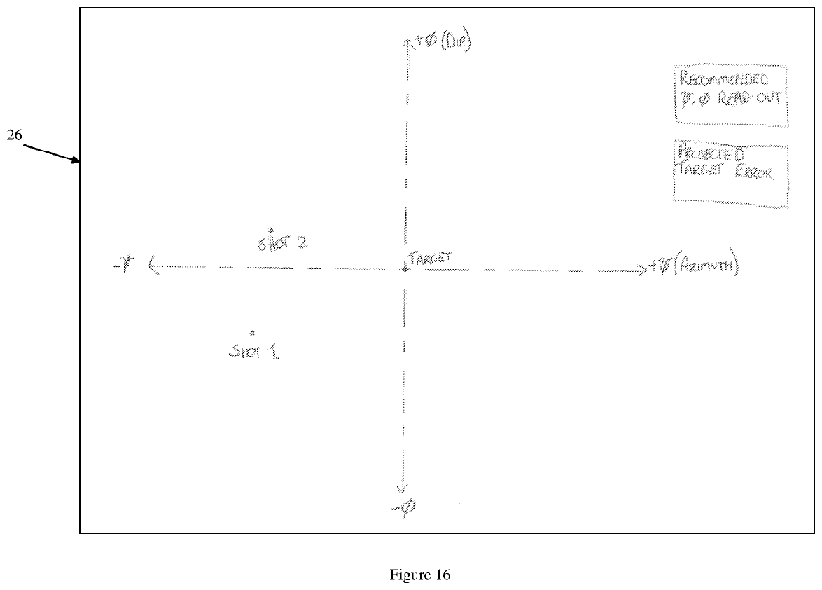

A preferred form of drilling target indicator 26 is illustrated in FIG. 16. The drilling target indicator display 26 is configured to display an indication of drill tip current position relative to drill tip target end position and at least one calculated angle of deflection required to arrive at the target end position from the current position The at least one calculated angle of deflection is calculated according to the method including the steps of:
d) establish a collar position of the drill rod;
e) Calculate coordinates to establish the drill tip current position within a drill hole as drilling is underway, at a time of survey, t_{survey}; and
f) Calculate at least one calculated angle of deflection required to arrive at the target end position from the current position.

The drilling target indicator of a preferred embodiment will preferably provide an indication to an operator of any deviation of a drill rod or similar downhole implement from an intended path given a fixed position (opposition) at or adjacent to the ground surface and an intended target end position. The drilling target indicator may provide an indication of the deviation from an intended path and/or provide an indication of any correction required in order for an off target implement to achieve the intended target in position.

Typically, the drilling target indicator will ascertain the current position at a time of survey of the drill tip or downhole implement tip according to two parameters, namely dip and azimuth. Preferably, the drilling target indicator will ascertain any deviation (and/or correction) relative to one or both of these parameters.

Establishing the collar position may be achieved by defining a position as the collar position and/or by calculation, for example at Time, t=0 or at Depth=0.

Any method may be used to calculate the current position of the tip of the downhole implement. Preferably the current position of the tip of the downhole implement will be established in real time in order to provide appropriate feedback in a timely manner to an operator to allow them to take corrective action if necessary. Preferably, the method of the present invention will be implemented while drilling.

Once the current position of the tip of the downhole implement has been established, the correction angle can be calculated in one or both of the parameters, dip and azimuth.

Preferably, once calculated, the current position of the tip of the downhole implement relative to the intended path and/or correction angle will typically be displayed on a display for an operator controlling the operation so that the operator can take appropriate steps to correct, any deviation.

The method can be implemented at any time during a drilling operation or at preset times in order to provide the displayed indication.

Preferably, the calculations undertaken to establish the important parameters include one or more of the following equations:

$$\begin{matrix}{Depth}_{n} = \sqrt{( {( {Y}_{LINE , n} - {Y}_{LNE , n - 1} )}^{2} - {{ɛ}_{ψ , n}}^{2} - {{ɛ}_{ϕ , n}}^{2} )} in meters & I \\ {ɛ}_{ψ , n} = ( {Depth}_{n} - {Depth}_{n - 1} ) \times tan ( {ψ}_{n - 1} - {ψ}_{collar} ) in meters & II \\ {ɛ}_{ϕ , n} = ( {Depth}_{n} - {Depth}_{n - 1} ) \times tan ( {ϕ}_{n - 1} - {ϕ}_{collar} ) in meters & III \\ {ψ}_{correction , n} = {ψ}_{collar} - {tan}^{- 1} ( {\sum }_{n = i , i = 0} ( {ɛ}_{ψ , i} ) / ( {Depth}_{final} - {\sum }_{n - 1 , i = 0} ( {Depth}_{n} ) ) ) & IV \\ {ϕ}_{correction , n} = {ϕ}_{collar} - {tan}^{- 1} ( {\sum }_{n = i , i = 0} ( {ɛ}_{ϕ , i} ) / ( {Depth}_{final} - {\sum }_{n - 1 , i = 0} ( {Depth}_{n} ) ) ) & V \\ {Y}_{LINE , 0} = {Depth}_{0} = {ɛ}_{ψ , 0} = {ɛ}_{ϕ , 0} = {ψ}_{0} = {ϕ}_{0} = {ψ}_{correction , 0} = {ϕ}_{correction , 0} = 0 & VI\end{matrix}$$

### Wherein:

Depth is distance aligned down collar—“direct distance”
Y_{LINE} is measured distance of location via Wire-line counter
ε is an error value in meters
Correction is final heading recommended to return to ideal of target end point
ψₙ is the azimuth reading of the nth slot; and
ϕₙ is the dip reading of the nth slot.

Preferably, the following mathematical models are used to predict the trajectory of the hole based on previous shots. In conjunction to these models, where possible the relative Northings, Eastings, and RLs are provided.

A preferred model assumes the azimuth and dip of subsequent shots will continue to change proportionally to the collar shot (referred to as the 0th shot in models), first shot, and the depth of each shot.

$${ψ}_{T , 0} = {ψ}_{0}$$

Where ω^{T,i}(seen at i=0) refers to the calculated trajectory azimuth of the ith shot, and ωᵢ(seen at i=0) refers to the measured azimuth of the ith shot.

$${θ}_{T , 0} = {θ}_{0}$$

Whereθ_{T,i}(seen at i=0) refers to the calculated trajectory dip of the ith shot, and θᵢ(seen at i=0) refers to the measured dip of the ith shot.

$${ψ}_{T , i} = \frac{( {ψ}_{1} - {ψ}_{0} ) \times {d}_{i}}{{d}_{1}} + {ψ}_{0}$$

Where refers to the measured/expected depth of the ith shot.

$${θ}_{T , i} = \frac{( {θ}_{1} - {θ}_{0} ) \times {d}_{i}}{{d}_{1}} + {θ}_{0}$$

Another model assumes azimuth and dip of the subsequent shot will continue proportionally to the first shot and previous shot, and the depth of each shot.

$${ψ}_{T , 0} = {ψ}_{0}$$

$${θ}_{T , 0} = {θ}_{0}$$

$${ψ}_{T , 1} = {ψ}_{0}$$

$${θ}_{T , 1} = {θ}_{0}$$

$${ψ}_{T , i} = \frac{( {ψ}_{i - 1} - {ψ}_{1} ) \times {d}_{i}}{{d}_{i - 1}} + {ψ}_{1}$$

$${θ}_{T , i} = \frac{( {θ}_{i - 1} - {θ}_{1} ) \times {d}_{i}}{{d}_{i - 1}} + {θ}_{1}$$

Another model assumes the azimuth and dip of the subsequent shots will continue to change proportionally to the previous two shots, and the depth of each shot.

$${ψ}_{T , 0} = {ψ}_{0}$$

$${θ}_{T , 0} = {θ}_{0}$$

$${ψ}_{T , 1} = {ψ}_{0}$$

$${θ}_{T , 1} = {θ}_{0}$$

$${ψ}_{T , i} = \frac{( {ψ}_{i - 1} - {ψ}_{i - 2} ) \times {d}_{i}}{{d}_{i - 1}} + {ψ}_{i - 2}$$

$${θ}_{T , i} = \frac{( {θ}_{i - 1} - {θ}_{i - 2} ) \times {d}_{i}}{{d}_{i - 1}} + {θ}_{i - 2}$$

Another model assumes the azimuth and dip of the subsequent shots will continue to change proportionally to the averaged azimuth and averaged dip.

$${ψ}_{T , i} = {\sum }_{j = 0}^{i - 1} {ψ}_{j}$$

$${θ}_{T , i} = {\sum }_{j = 0}^{i - 1} {θ}_{j}$$

In addition to the abovementioned model specific equations, the following equations are preferably used in any one of the models.

$${Δ RL}_{T , i} = ( {d}_{n} - {d}_{i} ) \times sin ( {θ}_{T , i} ) + {Δ RL}_{i}$$

Where ΔRL_{T,i} refers to the calculated relative level at end of hole, calculated from the ith shot; ΔRLᵢ refers to the relative level of the ith shot; and dᵢ refers to the depth of the hole at the ith shot as reported from the wireline counter and dₙ refers to the final depth of the hole as provided.

$${Δ E}_{T , i} = ( {d}_{n} - {d}_{i} ) \times sin ( {ψ}_{T , i} ) + {Δ E}_{i}$$

Where ΔE_{T,i} refers to the calculated relative Eastings at end of hole, calculated from the ith shot; ΔEᵢ refers to the relative Eastings of the ith shot

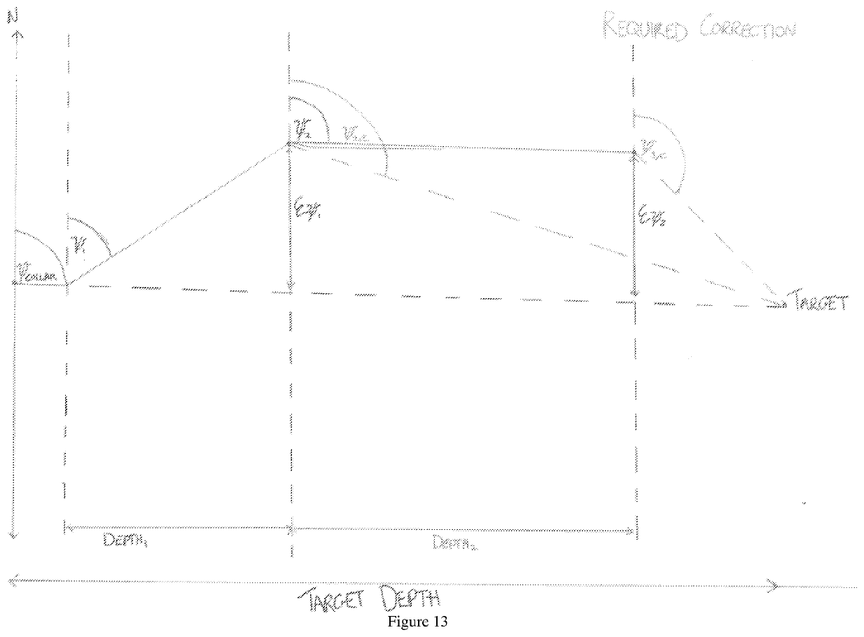

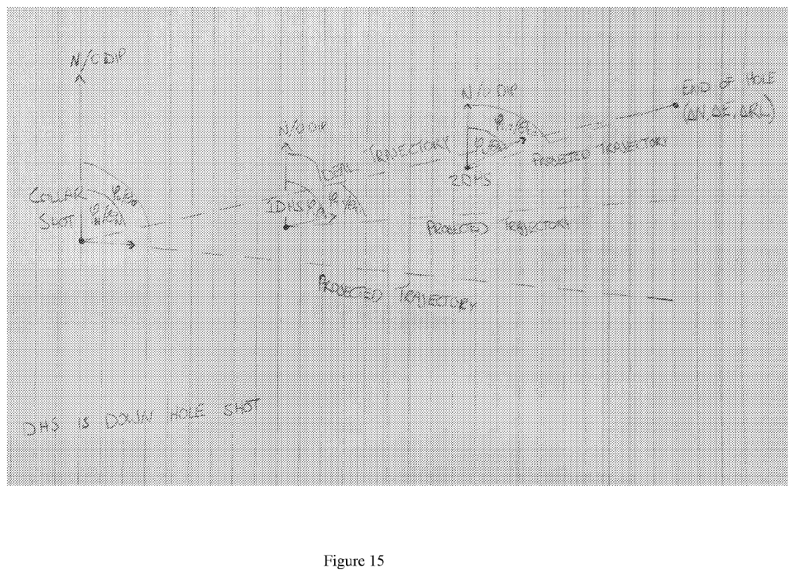

The abovementioned parameters and models are shown schematically and graphically in FIGS. 13, 14 and 15.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An inertial measurement unit configured for use with a downhole implement, comprising:
a primary casing removably and coaxially attached to a guide rod which is locatable within the hollow interior or bore of the downhole implement and can translate along the length of the implement;
a secondary casing enclosing the primary casing;
a primary sensor device mounted in the primary casing to measure acceleration and/or angular rate on at least one of an X-axis, Y-axis and Z-axis;
a secondary sensor device mounted in the secondary casing to measure acceleration and/or angular rate on at least one of an X-axis, Y-axis and Z-axis; and
wherein during an indexing process, the secondary sensor is adapted to be rotatably indexed relative to at least one of the X-axis, Y-axis and Z-axis independently of the primary sensor to thereby provide information regarding bias of the inertial measurement unit on at least one of the X-axis, Y-axis and Z-axis.

2. The inertial measurement unit of claim 1 wherein the primary casing is configured to be fixed in location and orientation while the secondary casing is indexed through 90° of rotation during part of the indexing process; and
wherein the secondary casing is configured to be fixed in location and orientation relative to the primary casing while the primary casing is indexed through 180° of rotation during part of the indexing process.

3. The inertial measurement unit of claim 1 wherein the secondary casing further comprises a drive mechanism configured to drive the primary casing through rotation during the indexing process and a drive mechanism configured to drive the secondary casing through rotation during the indexing process.

4. The inertial measurement unit of claim 3 wherein the primary casing acts as a drive base for the drive mechanism to rotate the secondary casing relative to the primary casing.

5. The inertial measurement unit of claim 1 wherein during the indexing process the relative flotation of the primary sensor device and the secondary sensor device is used to calculate the bias of the primary sensor device for one of the x-axis y-axis or z-axis.

6. The inertial measurement unit of claim 1 wherein the primary sensor device comprises a gyroscope and accelerometer for each of the X-axis, Y-axis and Z-axis, and the secondary sensor device comprises a gyroscope for each of the X-axis, Y-axis and Z-axis

7. A method of determining bias in an inertial measurement unit comprising a primary sensor device and a secondary sensor device comprising the steps of:
fixing the location and orientation of the primary sensor device;
indexing the secondary sensor device in a first axis through 90° of rotation relative to the primary sensor device;
indexing the primary sensor device and secondary sensor device in an axis perpendicular to the first axis through 180° of rotation;
indexing the secondary sensor device in the first axis though −90° of rotation;
indexing the primary sensor device and secondary sensor device in the axis perpendicular to the first axis through −180° of rotation;
calculating the bias of the inertial measurement unit relative to the first axis using the data collected by the primary sensor device and secondary sensor device.

8. The method of determining the bias in an inertial measurement unit of claim 7 wherein:
the indexing steps are repeated for the 2 axes perpendicular to the first axis.

9. An encoder steering assembly for steering an inertial measurement unit relative to a downhole implement comprising:
a housing insertable into the hollow bore of the downhole implement;
an encoder wheel configured to rotate about a first axis;
a mounting assembly configured to rotate about a second axis;
a drive to rotate the mounting assembly about the second axis;
wherein the encoder wheel is mounted in the mounting assembly such that the first axis and the second axis are perpendicular; and
wherein the inertial measurement unit and mounting assembly is mounted in the housing such that the encoder wheel can steer the housing relative to the downhole implement.

10. The encoder steering assembly of claim 9 wherein the encoder wheel extends outside the housing and abuts an inner surface of the downhole implement such that adjusting the angle of the at least one encoder wheel steers the inertial measurement unit as the inertial measurement moves relative to the downhole implement.

11. The encoder steering assembly of claim 9 wherein the at least one encoder wheel is a driven wheel.

12. The encoder steering assembly of claim 9 wherein the encoder wheel is biased outwardly into abutment with an interior surface of the hollow bore of the downhole implement.

13. A drilling target indicator including a display configured to display an indication of drill tip current position relative to drill tip target position and an angle of deflection required to arrive at the target position from the current position, wherein the angle of deflection determined according to the method including the steps of:
establishing a collar position of the drill rod associated with the drill tip;
calculating coordinates to establish the drill tip current position within a hole as drilling is underway; and
calculating an angle of deflection required to arrive at the target position from the current position.

14. The drilling target indicator of claim 15 wherein the display provides an indication to Clean Copy Docket No.: 0116.1111 an operator of any deviation of the drill rod from an intended path.

15. The drilling target indicator of claim 15 wherein the display provides an indication of a correction required for an off-target drill tip to achieve the intended target position.

16. The drilling target indicator of claim 15 wherein the angle of deflection is displayed according to dip and azimuth coordinates.

17. The drilling target indicator pf claim 15 wherein the current position of the tip of the downhole implement is established with an inertial measurement unit

18. An inertial measurement unit including at least one sensor device mounted on an X-axis, Y-axis and Z-axis and at least one secondary sensor device mounted on the X-axis, Y-axis or Z-axis wherein the at least one secondary sensor device is mounted to be rotatably indexed relative to the X-axis, Y-axis or Z-axis independently relative to the at least one sensor device.

19. A method of increasing the effective rate of rotation at which an inertial measurement unit comprising a sensor and housing operates, comprising the step of:
rotating the sensor in an opposite direction to a rotation of the housing such that the sensor remains within a functional limit to rate of rotation.

20. The method of claim 19 wherein the rotation of the sensor in an opposite direction is achieved by a motor driving the sensor relative to the housing.
